(19) United States
(12) Patent Application Publication
(10) Pub. No.: US 2026/0213229 A1
(43) Pub. Date: Jul. 23, 2026

(54) HUMIDIFIER

(71) Applicant: MAHLE International GmbH, Stuttgart (DE)

(72) Inventors: Michael Walz, Filderstadt (DE); Samuel Kohler, Weil im Schoenbuch (DE)

(21) Appl. No.: 19/455,365

(22) Filed: Jan. 21, 2026

(30) Foreign Application Priority Data
Jan. 22, 2025 (DE) 102025102319.0

(51) Int. Cl. H01M 8/04119

(52) U.S. Cl. CPC H01M 8/04126

(57) ABSTRACT

A humidifier for humidifying a first gas stream using a humid second gas stream includes a plastic housing with a base defining a recess and a trough for collecting accumulated water. A metal pipe section fluidically connects a drain opening in the trough to a water outlet on the housing exterior. An electric heating device is thermally coupled to the metal pipe section to heat the draining fluid and prevent freezing within the drainage path.

### CROSS-REFERENCE TO RELATED APPLICATION

This application claims priority to German Patent Application No. DE102025102319.0, filed on Jan. 22, 2025, the contents of which is hereby incorporated by reference in its entirety.

### TECHNICAL FIELD

The present disclosure relates to a humidifier for humidifying a dry first gas stream by means of a humid second gas stream, in particular for a fuel cell system.

### BACKGROUND

Such a humidifier can be used in particular in a fuel cell system to humidify dry cathode supply air with the aid of humid cathode exhaust air. In principle, however, any other applications for such a humidifier are also conceivable. For example, in the context of building air conditioning, humid building exhaust air can be used to humidify dry building supply air. The same applies to climate chambers and climate cabinets, where constant humidity with air exchange is required. In this context, humidity refers to water that can occur in liquid or gaseous form, or in the form of droplets or vapor, i.e., in gaseous and droplet form. Water may accumulate in the humidifier, particularly due to condensation, which can collect in the housing and freeze at sufficiently low ambient temperatures. This can impair the functionality of the humidifier.

A humidifier of this type is known from DE 10 2021 204 250 A1 and has a plastic housing with a recess in the base of the housing, in which there is a trough for collecting water that accumulates in the housing. Furthermore, there is a drain opening inside the trough, while on the outside of the housing there is a water outlet for draining water, which is fluidically connected to the drain opening. This allows water that collects in the housing or trough to be drained out of the housing through the drain opening and water outlet. In the well-known humidifier, the base of the housing in the area of the trough is equipped with a heating channel through which a heating medium can flow. This prevents the water that has accumulated in the housing or trough from freezing. Frozen water in the trough area can also be thawed using the heating channel. The heating channel has a heating medium inlet at the base of the housing for supplying the heating medium and a heating medium outlet for discharging the heating medium, and is therefore comparatively complex in design and relatively large.

### SUMMARY

The present disclosure addresses the problem of providing an improved or at least different embodiment for a humidifier of the above-mentioned type, which is characterized in particular by reduced complexity, while at the same time striving for a compact design.

The disclosure solves this problem by the subject matter of the independent claim. Advantageous embodiments are the subject matter of the dependent claims.

The disclosure is based on the general idea of equipping the humidifier with an electric heating device and a metal pipe section that is connected to the heating device for heat transfer and connects the drain opening to the water outlet. An electric heating device requires little installation space and is relatively easy to implement. The use of a metal pipe section that can be heated by the heating device simplifies the transfer of heat to the water. This allows the electric heating device to work particularly efficiently in conjunction with the pipe section.

Specifically, it is proposed that the humidifier comprises a metal pipe section which forms the drain opening at one end and the water outlet at the other end and connects the drain opening fluidically to the water outlet. In addition, the humidifier according to some implementations of the disclosure has an electric heating device that is connected directly or indirectly to the pipe section for heat transfer. The pipe section has two pipe ends in the usual manner and is configured according to some implementations of the disclosure so that one pipe end forms the drain opening, while the other pipe end forms the water outlet. The heat input into the pipe section that can be achieved with the aid of the heating device thus reaches the drain opening and the water outlet directly and extends in the pipe section from the drain opening to the water outlet, whereby an essential component of the water drainage from the housing is protected against icing or can be easily de-iced.

In this context, “configuration” is synonymous with “design” and/or “setup,” so that the phrase “configured in such a way that” is synonymous with the phrase “designed in such a way that” and/or “set up in such a way that.”

According to an advantageous embodiment, the heating device may be provided to extend to a drainage area located in the trough, in particular a central drainage area, into which the drain opening opens. This causes heat to be conducted into the pipe section close to the drain opening, providing particularly effective protection against icing and enabling particularly effective de-icing.

According to an advantageous embodiment, the humidifier may be provided with a metal heater body which is connected to the heating device in a heat-transferring manner, in particular directly, on the one hand, and is connected to the pipe section in a heat-transferring manner, preferably directly, on the other hand. In this way, the heating device can transfer heat directly to the heater body, which can transfer the heat directly to the pipe section. The heat-transferring connection, which is preferably created by direct contact, generates heat conduction from the heating device via the heater body to the pipe section, enabling the heating device to operate particularly efficiently and requiring comparatively little electrical energy.

According to an advantageous embodiment, the heater body may be provided with a metal shell forming the trough, which is arranged in the recess and in which the drain opening is located. The water that accumulates in the housing tends to collect in the trough. The formation of a trough in the heater body shell simplifies and concentrates the heat transfer to the water accumulated in the trough. This increases the efficiency of the heating device.

According to an advantageous embodiment, a seal, in particular a ring-shaped seal, may be provided in the recess between the shell and the housing. This prevents water from penetrating into a rear space within the recess that faces away from the trough.

According to an advantageous embodiment, it may be provided that the heater body is manufactured in one piece with the shell, so that the shell is formed by an integral part of the heater body. For example, the heater body is a cast part that already has the shell. The one-piece construction can be implemented particularly cost-effectively. However, the improved heat conduction within the one-piece heater body is particularly advantageous.

According to an advantageous embodiment, the heater body may have at least one metal fin extending into the trough so that it comes into direct contact with water collecting in the trough. With the help of such a fin, icing of the water in the trough can be easily prevented or easily thawed. Heating the heater body also heats the respective fin, allowing the heat to be easily transferred to the water via the fin.

According to an advantageous embodiment, the respective fin may be arranged on the aforementioned shell. Heating the heater body thus allows the shell to transfer heat to the water in the trough at the edges, while the respective fin can transfer the heat within the trough to the water. This makes the heating device particularly efficient.

According to an advantageous embodiment, the heater body can be manufactured in one piece with the respective fin, so that the respective fin is formed by an integral part of the heater body. For example, the heater body can be a cast part that is already equipped with the respective fin. The integral design improves heat conduction to the respective fin.

A particularly advantageous configuration is one in which the heater body is manufactured in one piece with the shell and the respective fin, so that the shell and the respective fin are each formed by an integral part of the heater body. For example, the heater body is a cast part that is already equipped with the shell and the respective fin.

According to an advantageous embodiment, the heater body may have at least two such fins, which are arranged and designed in such a way that they form a free space between them, which connects a drainage area located in the trough, in particular a central drainage area, into which the drain opening opens, fluidically with an outer area of a housing interior located outside the trough. When the humidifier is installed, the outer area outside the trough is located in the interior of the housing above the trough. The free space formed between the two fins represents a drainage channel that connects the outer area to the drainage area, where the drain opening is located. Heating the fins protects the water in this free space from freezing and allows it to thaw more easily. In the event of ice formation, this allows the free space or drainage channel to be defrosted preferentially, enabling water to be quickly drained from the housing through the free space or drainage channel.

According to an advantageous embodiment, it may be provided that the trough is bordered by a trough edge that adjoins the base of the housing. It is practical for the two fins to extend, in particular parallel to each other, to the edge of the trough or beyond the edge of the trough. This means that the free space or the aforementioned drainage channel extends to the edge of the trough or beyond, enabling efficient drainage even when the water level in the housing is relatively high.

According to an advantageous embodiment, the heater body may have a metal pipe holder that is open toward the trough and into which the pipe section protrudes in such a way that the drain opening opens into the pipe holder or into the trough. Heating the heater body therefore heats the pipe holder, which in turn heats the pipe section. This allows the pipe section to be heated particularly efficiently in the area of the drain opening.

According to an advantageous embodiment, the pipe holder may have an internal thread and the pipe section may have an external thread that matches the internal thread, so that the pipe section is screwed into the pipe holder. This simplifies the installation of the humidifier. At the same time, this creates good heat conduction from the heater body to the pipe section.

In principle, an embodiment may be provided in which the heater body is manufactured in one piece with the pipe section, so that the pipe section is formed by an integral part of the heater body. It is clear that the one-piece heater body may optionally also have the aforementioned shell and/or the respective aforementioned fin. The pipe holder mentioned above can then be omitted.

According to another advantageous embodiment, the heater body may be manufactured in one piece with the pipe holder, so that the pipe holder is formed by an integral part of the heater body. The heater body can be a cast part that is already equipped with the pipe holder.

According to an advantageous embodiment, the heater body can be manufactured in one piece with the pipe holder and with the shell and/or the respective fin, so that the pipe holder and the shell and/or the respective fin are each formed by an integral part of the heater body. The heater body, which is designed as a cast part, for example, can be equipped with the pipe holder and the shell and/or the respective fin.

According to an advantageous embodiment, the heating device may comprise at least one PTC element that is coupled to the heater body in a heat-transferring manner. PTC stands for Positive Temperature Coefficient, as usual. Such PTC elements are characterized by high energy efficiency.

According to an advantageous embodiment, the base of the housing may be provided with a through-opening at the recess, through which the pipe section extends into the trough. This simplifies the design of the humidifier. In addition or as an alternative, the base of the housing may have a connection opening at the recess through which the heating device extends into the recess. This measure also simplifies the implementation of the humidifier.

According to another advantageous embodiment, it may be provided that the pipe section is sealed to the recess opposite the housing by means of an external seal, in particular an annular seal. In addition or as an alternative, the pipe section can be sealed against the heater body by means of an internal seal, particularly a ring-shaped seal, on the trough, particularly in the pipe holder. On the one hand, these measures prevent unwanted water escaping or leaking from the housing. Similarly, contaminants are prevented from entering the housing.

Other important features and advantages of the disclosure can be seen from the dependent claims, from the drawings, and from the associated description of the figure based on the drawings.

It is understood that the above-mentioned features and those yet to be explained below can be used not only in the combination indicated in the respective case, but also in other combinations or on their own, without deviating from the scope of the disclosure defined by the claims. The components of a superordinate unit, such as a device, an apparatus, or an arrangement, which are described separately, having been mentioned above or to be mentioned below, can represent separate components of this unit or can form integral regions or sections of this unit, even if this is shown differently in the drawings.

Preferred exemplary embodiments of the disclosure are shown in the drawings by way of example and will be explained in more detail in the following description, wherein identical reference numbers refer to identical or similar or functionally identical elements.

### BRIEF DESCRIPTION OF THE DRAWINGS

The drawings, each schematically, show in:

FIG. 1 shows a simplified sectional view of a humidifier in the area of a base of the housing;

FIG. 2 shows an enlarged detail II from FIG. 1 in the area of a trough with a heating device, a heater body, and a pipe section;

FIG. 3 shows a sectional view corresponding to section lines III in FIG. 2;

FIG. 4 shows an isometric view from above of the heater body with the heater body and the pipe section; and

FIG. 5 shows an isometric view from below of the heater body with the heater body and the pipe section.

### DETAILED DESCRIPTION

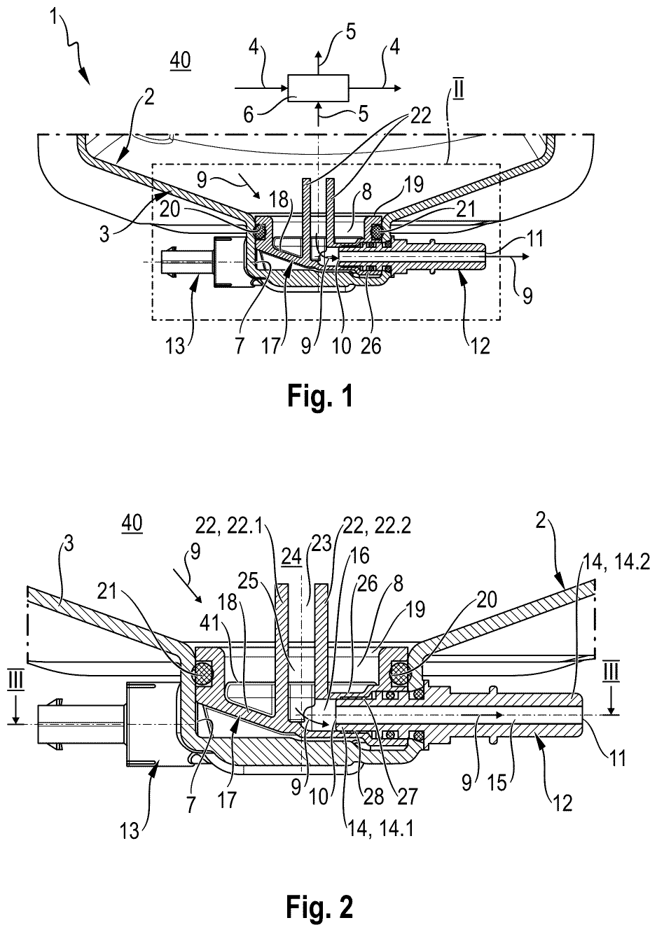

According to FIG. 1, humidifier 1, which is only partially shown here, comprises a plastic housing 2 with a base of the housing 3. Humidifier 1 is used to humidify a dry first gas stream 4 by means of a humid second gas stream 5. For this purpose, a diaphragm block 6, shown here in simplified form, can be arranged in housing 2 or in an interior space 40 enclosed by housing 2, which can be flowed through by the first gas stream 4 and the second gas stream 5 in a media-separated manner and which, with the aid of membranes not shown in detail here, causes the transfer of humidity from the second gas stream 5 to the first gas stream 4.

A recess 7 is formed in the base of the housing 3, in which there is a trough 8 for collecting water 9 that accumulates in the housing 2, for example due to condensation, and is indicated by arrows in FIGS. 1 and 2. There is a drain opening 10 inside the trough 8. On the outside of housing 2 there is a water outlet 11, which serves to drain water 9 and is fluidically connected to the drain opening 10 for this purpose.

The humidifier 1 shown here also features a metal pipe section 12 and an electric heating device 13. The pipe section 12 is configured in a straight line here and has two pipe ends 14 facing away from each other axially, namely a first pipe end 14.1 and a second pipe end 14.2. The first pipe end 14.1 is located inside the housing 2 and forms the drain opening 10. The second pipe end 14.2 is located outside the housing 2 and forms the water outlet 11. Inside the pipe section 12 there is a pipe interior 15 which connects the two pipe ends 14 fluidically with each other. As a result, the drain opening 10 and the water outlet 11 are fluidically connected to each other by the pipe section 12. The electric heating device 13 is connected directly or indirectly to the pipe section 12 in a heat-transferring manner. A drainage area 16 is formed in the trough 8, into which the drain opening 10 opens. The drainage area 16 is preferably located centrally in the trough 8. In addition or alternatively, the drainage area 16 is located at the lowest point of the trough 8 or forms the lowest point of the trough 8. The heating device 13 is conveniently configured so that it extends to the drainage area 16. This allows the heating device 13 to introduce heat into the pipe section 12 in the drainage area 16, i.e., relatively close to the drain opening 10.

According to FIGS. 1 to 5, in the preferred embodiment shown here, the humidifier 1 may also have a heater body 17 made of metal. The heater body 17 is connected to the heating device 13 on one side, either directly or indirectly, for heat transfer. On the other hand, the heater body 17 is connected to the pipe section 12 directly or indirectly for heat transfer. The preferred embodiment shown here is one in which the heater body 17 is connected directly to both the heating device 13 and the pipe section 12 for heat transfer. This means that the heater body 17 is in direct contact with both the heating device 13 and the pipe section 12. The heater body 17 may have a metal shell 18 that is shaped and positioned to form the trough 8. The shell 18 is arranged in the recess 7 for this purpose. Furthermore, the drain opening 10 is located in the shell 18. The trough 8 is bordered by a trough edge 19, which adjoins the base of the housing 3 and is also formed here on the heater body 17. Adjacent to the edge of the trough 19, the heater body 17 has a closed circumferential annular groove 20 on the outer radial side, in which a heater body seal 21 is arranged, which is suitably designed in a ring shape. The heater body seal 21 seals the heater body 17 in the recess 7 against the housing 2.

The heater body 17 also has at least one fin 22. In the example shown, purely by way of example and without limiting the generality, exactly two fins 22 are formed on the heater body 10, namely a first fin 22.1 and a second fin 22.2. The respective fin 22 extends into the trough 8 in such a way that the fin 22 comes into contact with water 9 that may be present in the trough 8. In the installation state of humidifier 1 shown, trough 8 is located at the bottom of housing 2. Furthermore, the base of the housing 3 is inclined toward the trough 8 or toward the recess 7, so that water 9 accumulating in the housing 2 flows along the base of the housing 3 toward the recess 7 due to gravity and enters the trough 8 there. The respective fin 22 is conveniently configured in a straight line and extends vertically in the examples shown here. In this case, the respective fin 22 can extend from the shell 18 and protrude upward from there.

According to the preferred embodiment of humidifier 1 shown here, at least the two fins 22 are provided, wherein these two fins 22 are arranged and designed such that they form a free space 23 between them, which fluidically connects the drainage area 16 to an outer area 24 of the housing interior 40, wherein said outer area 24 is located in the housing interior 40 outside the trough 8. When humidifier 1 is installed correctly, this outer area 24 is located above the trough 8 and inside the housing interior 40. The free space 23 forms a drainage channel 25 that leads from the outer area 24 to the drainage area 16. In the example shown, the first fin 22.1 protrudes from shell 18, while the second fin 22.2 protrudes from a pipe holder 26, which will be discussed in more detail below. This means that the drainage area 16 or the drainage channel 25 extends to below the second fin 22.2. If so much water accumulates in housing 2 that the water level rises above trough 8, a corresponding block of ice may form at sufficiently low ambient temperatures, blocking free space 23 and thus drainage channel 25 and also pipe section 12 from drain opening 10 to water outlet 11. The heating device 13 heats the heater body 17, which also heats the fins 22. This causes the free space 23 to be thawed preferentially, thereby unblocking the drainage channel 25. Furthermore, the direct contact between the heater body 17 and the pipe section 12 also heats the pipe section 12 and preferentially thaws the ice contained therein. This primarily thaws and unblocks an area that leads from the outer area 24 through the free space 23 or the drainage channel 25 to the drainage area 16 and from the drain opening 10 through the pipe section 12 to the water outlet 11. This allows a large amount of water to be drained from housing 2 relatively quickly. In the example shown, the two fins 22 extend parallel to each other and beyond the edge of the trough 19, so that a relatively large block of ice can be removed in the area of the fins 22 and the drainage channel 25 can be unblocked.

The heater body 17 may also have a pipe holder 26 made of metal and open toward the trough 8. The pipe section 12 protrudes into the pipe holder 26 in such a way that the discharge opening 10 opens into the pipe holder 26. In the example shown, the drainage area 16 is largely formed in the pipe holder 26. In the example shown, it is also provided that the pipe holder 26 has an internal thread 27, while the pipe section 12 has a matching external thread 28. Accordingly, pipe section 12 is screwed into pipe holder 26. In the preferred example shown here, the heater body 17 is manufactured in one piece with the shell 18, the trough edge 19, the respective fin 22, and the pipe holder 26. Thus, the shell 18, the trough edge 19, the respective fin 22, and the pipe holder 26 are each formed by an integral part of the heater body 17. This results in a high degree of integration for the heater body 17, which facilitates the assembly of the humidifier 1 and reduces manufacturing costs.

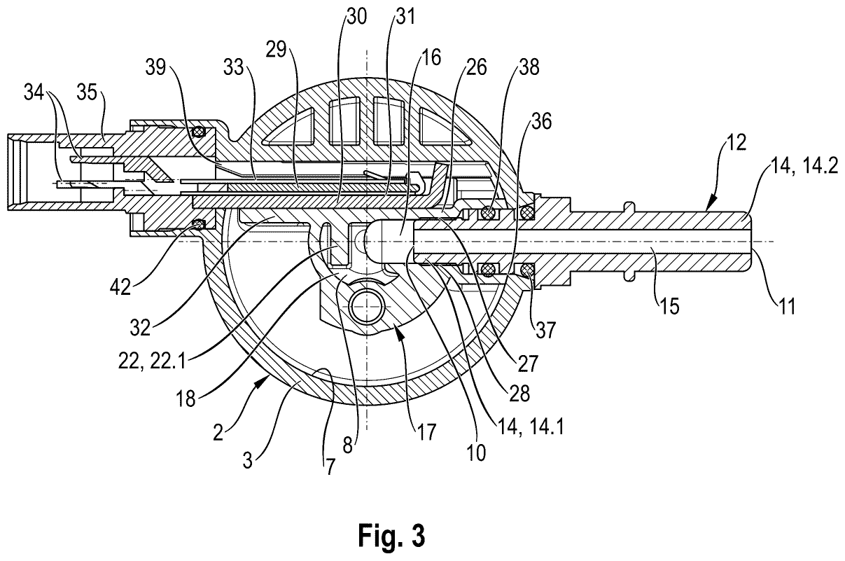

According to FIGS. 3 and 5, the heating device 13 has at least one Positive Temperature Coefficient (PTC) element 29 that is thermally coupled to the heater body 17. For this purpose, the heating device 13 may comprise a metal plate 30 which is in contact with the PTC element 29 via a first contact strip 31. The metal plate 30, for its part, rests directly and flatly against a metal wall 32 of the heater body 17, thereby enabling large-area heat transfer between the heating device 13 and the heater body 17. The electrical contact of the PTC element 29 is made via the aforementioned first contact strip 31 and a second contact strip 33. The two contact strips 31 and 33 lead to electrical contacts 34, which are arranged in a plug 35 that serves as a carrier for the PTC element 29 and the metal plate 30.

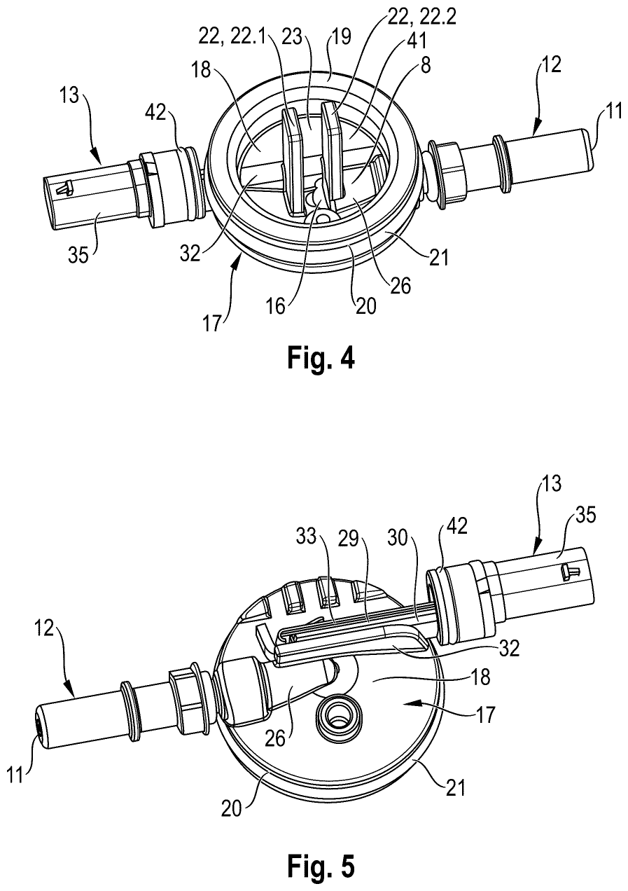

Positioning the heating device 13 close to the outlet opening 10 creates a raised step 41 within the trough 8, which transitions via the metal wall 32 into a lower area of the trough 8, where the drainage area 16 and the drain opening 10 are located. According to FIG. 4, the two fins 22 are directly adjacent to the metal wall 32, which improves heat transfer to the fins 22.

The sectional view in FIG. 3 contains an offset resulting from the fact that the section line III according to FIG. 2 runs centrally through the heating device 13 on the one hand and centrally through the pipe section 12 on the other, wherein the heating device 13 is arranged slightly offset in the height direction relative to the pipe section 12. When the humidifier is installed, the height direction is vertical.

The base of the housing 3 has a through-opening 36 at the recess 7 according to FIG. 3, through which the pipe section 12 extends into the trough 8. According to FIG. 3, the pipe section 12 is sealed against the housing 2 by means of a suitable annular outer seal 37 at the recess 7 and is also sealed against the heater body 17 by means of a suitable annular inner seal 38 at the trough 8, in the example in the pipe holder 26. In addition, the base of the housing 3 has a connection opening 39 here at the recess 7, through which the heating device 13 extends into the recess 7. The heating device 13 or the plug 35 is sealed against the housing 2 by means of a functional ring-shaped plug seal 42.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase at least one of successive elements separated by the word “and” (e.g., “at least one of A and B”) is to be interpreted the same as the term “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. All matter contained in the above description or shown in the accompanying drawings shall be interpreted as illustrative only and not limiting. Changes in detail or structure may be made without departing from the present disclosure.

1. A humidifier for humidifying a first gas stream using a humid second gas stream, comprising:
a plastic housing having a base defining a recess;
a trough disposed within the recess configured to collect water accumulating in the plastic housing, wherein the trough includes a drain opening;
a water outlet located on an exterior of the plastic housing;
a metal pipe section having a first end defining the drain opening and a second end defining the water outlet, wherein the metal pipe section fluidically connects the drain opening to the water outlet; and
an electric heating device thermally coupled to the metal pipe section.

2. The humidifier of claim 1, wherein the electric heating device extends to a drainage area located within the trough, into which the drain opening opens.

3. The humidifier of claim 1, further comprising a metal heater body thermally coupled to the electric heating device on a first side and to the metal pipe section on a second side.

4. The humidifier of claim 3, wherein the metal heater body comprises a metal shell that forms the trough located in the recess.

5. The humidifier of claim 4, wherein the metal shell is integrally formed as a single piece with the metal heater body.

6. The humidifier of claim 3, wherein the metal heater body comprises at least one metal fin extending into the trough configured to contact water collecting in the trough.

7. The humidifier of claim 4, wherein the metal heater body comprises at least one metal fin extending into the trough, and wherein the at least one metal fin is disposed on the metal shell.

8. The humidifier of claim 6, wherein the at least one metal fin is integrally formed as a single piece with the metal heater body.

9. The humidifier of claim 6, wherein:
the at least one metal fin comprises a first metal fin and a second metal fin, the first metal fin and the second metal fin arranged to define a free space therebetween, and
the free space fluidically connects a drainage area located in the trough to an outer area of a housing interior located outside the trough.

10. The humidifier of claim 9, wherein:
the trough is bordered by a trough edge adjoining the base of the plastic housing; and
the first and second metal fins extend to or beyond the trough edge.

11. The humidifier of claim 3, wherein the metal heater body comprises a metal pipe holder open towards the trough, and wherein the metal pipe section protrudes into the metal pipe holder such that the drain opening opens into the metal pipe holder or into the trough.

12. The humidifier of claim 11, wherein:
the metal pipe holder comprises an internal thread and the metal pipe section comprises a matching external thread; and
the metal pipe section is threadably engaged with the metal pipe holder.

13. The humidifier of claim 11, wherein the metal pipe holder is integrally formed as a single piece with the metal heater body.

14. The humidifier of claim 3, wherein the electric heating device comprises at least one Positive Temperature Coefficient (PTC) element thermally coupled to the metal heater body.

15. The humidifier of claim 1, wherein the base of the plastic housing defines a through-opening at the recess through which the metal pipe section extends into the trough, or a connection opening at the recess through which the electric heating device extends into the recess.

16. The humidifier of claim 2, further comprising a metal heater body thermally coupled to the electric heating device on a first side and to the metal pipe section on a second side.

17. The humidifier of claim 4, wherein the metal heater body comprises at least one metal fin extending into the trough configured to contact water collecting in the trough.

18. The humidifier of claim 5, wherein the metal heater body comprises at least one metal fin extending into the trough configured to contact water collecting in the trough.

19. The humidifier of claim 7, wherein:
the at least one metal fin comprises a first metal fin and a second metal fin, the first metal fin and the second metal fin arranged to define a free space therebetween, and the free space fluidically connects a drainage area located in the trough to an outer area of a housing interior located outside the trough.

20. The humidifier of claim 8, wherein:
the at least one metal fin comprises a first metal fin and a second metal fin, the first metal fin and the second metal fin arranged to define a free space therebetween, and the free space fluidically connects a drainage area located in the trough to an outer area of a housing interior located outside the trough.
